(19) United States
(12) Patent Application Publication
(10) Pub. No.: US 2003/0142353 A1
(43) Pub. Date: Jul. 31, 2003

(54) Printing device having memory usage indicator

(76) Inventors: Kram Henry Allen, Meridian, ID (US); Linn James Kropf, Boise, ID (US); Clifford Lee Coppinger, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/062,783

(22) Filed: Jan. 29, 2002

(51) Int. Cl. G06F 15/00; B41B 1/00

(52) U.S. Cl. 358/1.16

(57) ABSTRACT

A printing device is provided, the printing device including memory configured to receive and store a pending print job, a print engine configured to print the pending print job onto a medium, a processor configured to determine an amount of memory utilized by the pending print job, and a memory usage indicator configured to display to a user a representation of the amount of memory utilized by the pending print job.

### TECHNICAL FIELD

The present invention relates to a printing device for printing onto media. More particularly, the invention concerns a printing device with a memory usage indicator configured to determine and display to a user an amount of memory utilized by a pending print job.

### BACKGROUND OF THE INVENTION

In many different use environments, printing devices may be shared by more than one user. For example, in an office environment, a printing device may be connected to a local area network (LAN), and may be configured to receive print jobs from any or all computers connected to the LAN. In this situation, the computers may send print jobs either directly to the printing device, or to a print queue located on the LAN at a location remote from the printing device. New print jobs may then be spooled to the printing device from the queue as the printing device completes the printing of prior print jobs.

Sometimes, two or more users may send print jobs to a selected printing device at approximately the same time. Thus, one of the users may arrive at the printing device only to find that the desired print job is stuck behind a prior print job, and thus has not yet been printed. Depending upon the size of the prior print job, the user may have to wait an undesirable length of time, thus wasting time and possibly lowering the user's productivity.

Although some computer systems have software that allows a user to view pending print jobs queued for printing at a selected printing device, this software typically does not show print jobs that have been sent to the printing device. Other software programs may allow a user to view limited information regarding the contents of the printing device memory, but these programs typically must be installed on each network computer to allow each user to view the contents of the printing device memory. Furthermore, a single version of the program may not be compatible with all operating systems. Thus, a different version of the program may be necessary for each operating system used on the network. This may be expensive.

### SUMMARY OF THE INVENTION

A printing device is provided, the printing device including memory configured to receive and store a pending print job, a print engine configured to print the pending print job onto a medium, a processor configured to determine an amount of memory utilized by the pending print job, and a memory usage indicator configured to display to a user a representation of the amount of memory utilized by the pending print job.

### BRIEF DESCRIPTION OF THE DRAWINGS

FIG. 1 is a perspective view of a printing device according to a first embodiment of the present invention.

FIG. 2 is a block diagram of a suitable logic system architecture for the embodiment of FIG. 1.

FIG. 3 is a schematic view of a first exemplary memory usage indicator indicating a first level of memory usage.

FIG. 4 is a schematic view of the memory usage indicator of FIG. 3, shown indicating a second level of memory usage.

FIG. 5 is a schematic view of a second exemplary memory usage indicator indicating a first level of memory usage.

FIG. 6 is a schematic view of the memory usage indicator of FIG. 5, shown indicating a second level of memory usage.

FIG. 7 is a schematic view of a third exemplary memory usage indicator digitally indicating percentage completion of a print job.

FIG. 8 is a schematic view of a fourth exemplary memory usage indicator digitally indicating a number of pages printed of a print job.

FIG. 9 is a flow diagram of a method of indicating progression of a pending print job according to one embodiment of the present invention.

### DETAILED DESCRIPTION OF THE PREFERRED EMBODIMENTS

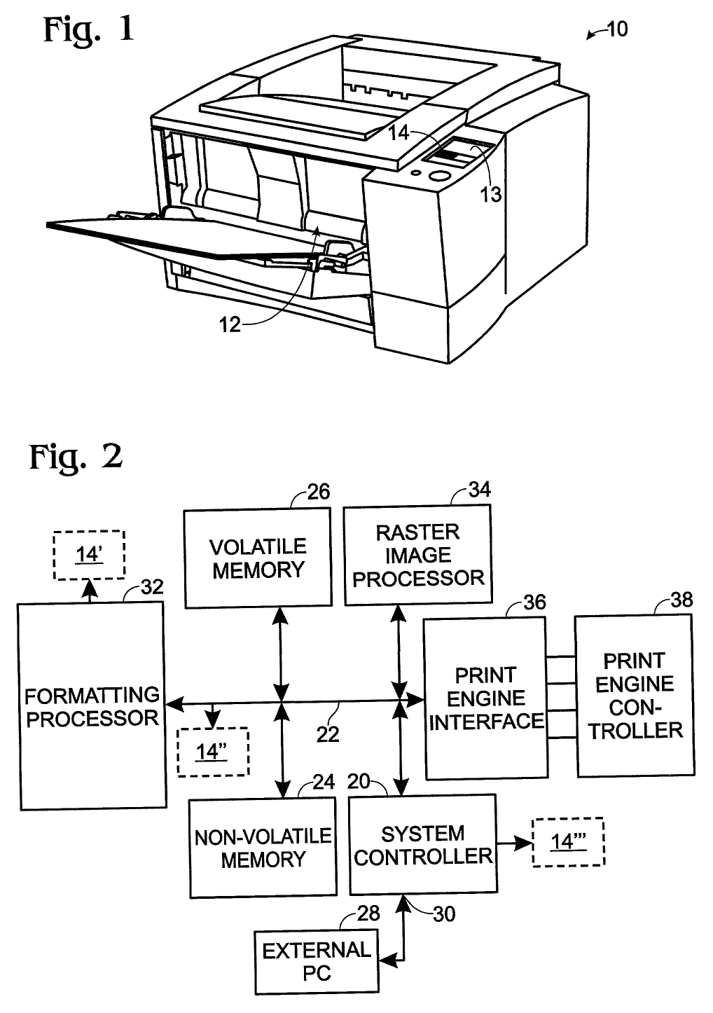

One embodiment of the present invention is depicted, generally at 10 in FIG. 1, as a desktop printing device configured to receive print jobs from an external device, such as a computer. While printing device 10 is depicted illustratively as a printer, the printing device may take any number of forms, including, but not limited to, a fax machine or a copier. Furthermore, while printing device 10 takes the form of a desktop printing device, it will be appreciated that printing device may be any desired size, large- or small-format.

Printing device 10 includes a print engine, indicated generally at 12, configured to print a pending print job onto media. Print engine 12 typically includes various components configured to perform such tasks as transferring ink or toner onto media, advancing the media through the printing device, and other mechanical functions related to printing. Printing device 10 also includes memory, described in more detail below, configured to store print jobs received from an external device.

In addition to the print engine and memory, printing device 10 includes a display 13 configured to display a memory usage indicator, or resource indicator, shown generally at 14 in FIG. 1. As will be described further, memory usage indicator 14 receives an indication of an amount of memory occupied by a pending print job, and presents a representation of an amount of memory utilized by the pending print job to a user. Memory usage indicator 14 may be configured to represent the utilization of the memory in any suitable manner. For example, memory usage indicator 14 may be configured to represent an amount of memory occupied by the pending print job, or an amount of free memory not occupied by the pending print job. Memory usage indicator 14 may also be configured to provide other information, such as the progress of the print job. In this sense, memory usage indicator 14 may also be thought of as a progress meter configured to indicate the progress of a print job to a user.

FIG. 2 shows a simple block diagram of an exemplary logic system architecture for printing device 10. As indicated, printing device 10 includes a system controller 20 and an internal bus 22. System controller 20, it will be appreciated, may be configured to perform any of a number of system functions, such as memory management, clock distribution and control of access to internal bus 22 by other components. It also will be appreciated that these particular functions are listed for exemplary purposes, and that system controller 20 may be further configured to control any desired system function.

As mentioned above, printing device 10 also includes memory. Typically, printing device 10 will include both non-volatile memory, indicated at 24 in FIG. 2, and volatile memory, indicated at 26. Non-volatile memory 24 is generally utilized for such purposes as storing printing device software, fonts and other permanent or semi-permanent data. Any suitable type of non-volatile memory may be used. Examples include ROM, PROM, EPROM, EEPROM and Flash memory, and combinations thereof. Similarly, volatile memory 26 may be any suitable type of volatile memory, such as SRAM or DRAM, and may include more than one type of memory. Volatile memory 26 is typically configured to store pending print jobs received from an external device 28, for example a personal computer (PC), via an external device interface 30.

Printing device 10 also typically includes other logic components, such as a formatting processor 32, a raster image processor 34, a print engine interface 36 and a print engine controller 38. Formatting processor 32 controls the preparation and formatting of information contained within a print job for printing, and is thus configured to read and execute instructions contained within a print job that are written in a page description language (PDL), such as Printer Control Language (PCL) or PostScript. Formatting processor 32 may be configured to be compatible with a single PDL, or multiple PDLs. Instructions written in a PDL that are contained within the print job typically include such instructions as the font or fonts to apply to the information, the location at which each page begins and ends, and other page appearance information.

Raster image processor 34 converts formatted print job information into a printable bitmap image. Raster image processor 34 may also perform other functions, such as enlarging the image to be printed. Once the printable image has been formed, the image is sent to print engine interface 36. Upon receipt of the image at interface 36, print engine controller 38 drives print engine 12 to print the image onto a medium.

Processing and printing of a pending print job typically occurs in a serial manner such that volatile memory 26 is continuously being freed as the print job progresses. Printing device 10 is configured to indicate this progression of the print job to a user via memory usage indicator 14.

Usage-indicator software executable to control the operation of memory usage indicator 14 is typically contained within non-volatile memory 24, and may be loaded into volatile memory 26 for execution during printer start-up. Formatter processor 32 may be configured to execute this usage-indicator software, or memory usage indicator 14 may include a dedicated processor for executing the software. The usage-indicator software may be configured to operate memory usage indicator 14 in any desired manner. Generally, the usage-indicator software will include instructions to perform the steps of determining a total length of a print job, tracking the progress of the print job, and updating memory usage indicator 14 to represent progress of the print job.

One possible way to implement these steps is as follows. First, when a print job is received in volatile memory 26, the total size of the print job may be detected and stored, either as an actual size, or as another number that represents the total size of the print job. At the same time, a counter configured to track the printing of the print job is initialized. Then, as printing commences and progresses, the counter may track the amount of data printed by increasing (or decreasing) in value with each unit of data processed. Periodically during the printing of the print job, the software may update memory usage indicator 14 to reflect the present value of the counter. Memory usage indicator 14 may be updated at any desired frequency. For example, memory usage indicator may be updated after the printing of each 10% increment of a print job is completed, or may be updated after either a larger or smaller increment is completed. The counter is increased continuously with printing until the value of the counter equals the total size of the print job, indicating that the print job has been completed. At this time, the counter may be re-initialized, and the printer may await receipt of a new print job.

Memory usage indicator 14 may have any suitable location within the logic system architecture of printing device 10. For example, memory usage indicator 14 may be connected directly to processor 32, as indicated at 14′, to internal bus 22, as indicated at 14″, to system controller 20, as indicated at 14′″, or to any other desired location. Moreover, it will be appreciated that the printing device architecture depicted in FIG. 2 is merely exemplary, and that a printing device according to the present invention may have any other suitable architecture, with any other desired arrangement of processors, controllers, memory, image enhancers, and other components, without departing from the scope of the present invention.

Memory usage indicator 14 may be configured to present the memory usage representation of memory usage either automatically, or when prompted by a user via an input device, such as a button on printing device 10 (not shown). Typically, the value representing the amount of volatile memory 26 used by the pending print job is obtained periodically, and the memory usage indicator 14 is automatically refreshed when each new value is obtained. Thus, changes to memory usage indicator 14 over time represent progress of the printing of a print job, and tell a user approximately how quickly the print job is progressing.

Memory usage indicator 14 may be configured to present any desired representation of the usage of volatile memory 26. For example, memory usage indicator 14 may be configured to display a graphical representation of the amount of volatile memory 26 used by a print job, or may display an alphanumeric representation.

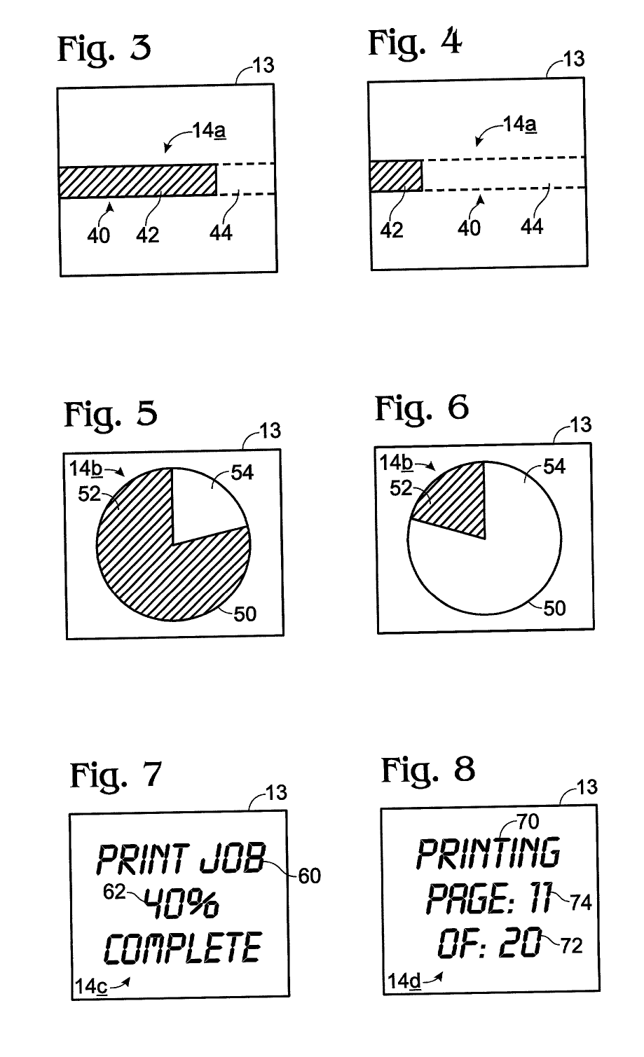

FIGS. 3-8 show examples of suitable memory usage indicators 14. FIGS. 3 and 4 show a graphical memory usage indicator 14a in the form of a bar 40 displayed on display 13. Bar 40 includes a darker portion 42 and a lighter portion 44, the sum of which may either represent the total amount of memory in volatile memory 26, or the total length of the currently pending print job. Darker portion 42 may be configured to display either an amount of volatile memory 26 used by a pending print job, or an amount of the volatile memory not used by the pending print job. Darker portion 42 may also represent an amount of time remaining before the completion of a current print job. Additionally, memory usage indicator 14a may include a legend or caption (not shown) to indicate to a user what quantity is represented by bar 40. While the contrast between the sections of the bar 40 are described as being “lighter” or “darker” in reference to FIGS. 3-4, it will be appreciated that the sections may be configured to contrast in any other manner. For example, the sections may be different colors, or may have different patterns.

When a new print job is loaded into volatile memory 26, memory usage indicator 14a changes to represent receipt of the new print job. For example, where darker portion 42 is configured to display the amount of volatile memory 26 occupied by the pending print job, the length of darker portion 42 increases when a new print job is loaded into volatile memory 26. Then, as the pending print job prints, the length of darker portion 42 is decreased to represent memory being freed during the printing process.

FIGS. 5 and 6 show a second example of a graphical memory usage indicator 14b suitable for use with the printing device of FIG. 1. In these figs., memory usage indicator 14b takes the form of a pie chart 50 displayed on display 13. As with bar 40, pie chart 50 includes a darker portion 52 and a lighter portion 54, the sum of which represents either the total size of the print job, or the total size of volatile memory 26. As with the example of FIGS. 3-4, darker portion 52 may be configured to display either an amount of volatile memory 26 used by a pending print job, or an amount of the volatile memory not used by the pending print job. Furthermore, as with the example of FIGS. 3-4, it will be appreciated that the terms “lighter portion” and “darker portion” refer to the appearance of the charts in the figures, and any other suitable scheme may be used to contrast the two regions of the pie chart.

When a new print job is loaded into volatile memory, the relative sizes of darker portion 52 and lighter portion 54 change to represent receipt of the new print job. As the pending print job prints, the sizes of darker portion 52 and lighter portion 54 again change correspondingly to indicate the decreasing amount of memory occupied by the pending print job. For example if darker portion 52 indicates the size of the pending print job, then the area of darker portion 52 grows when the print job is first loaded into memory, and then decreases as the print job is printed.

Rather than displaying a graphical representation of memory usage, memory usage indicator 14 may instead be configured to display an alphanumeric representation of the amount of memory occupied by the pending print job. Any suitable alphanumeric display may be used. For example, memory usage indicator 14 may be configured to display on display 13 text such as “Memory ______% free”, “Memory ______% occupied”, or other such message directly indicating the amount of memory occupied by a pending print job. Then, a numeric representation of the amount of memory used by the print job may be filled into the blank field, and periodically updated to show the progression of the print job.

Memory usage indicator 14 may also be configured to display other values besides the amount of volatile memory 26 occupied by the pending print job. For example, in FIG. 7, memory usage indicator 14c includes a fixed legend 60 that reads “Print Job ______% Complete”, and also includes a blank, variable field 62 where the amount of free memory may be displayed. This may be more desirable to a user of the printing device, as it more directly tells the user how much longer the current print job will take.

FIG. 8 shows another example of a suitable alphanumeric memory usage indicator 14d. Memory usage indicator 14d includes a first variable field 72 indicating the total length of the current print job in pages, a second variable field 74 indicating the current page being printed, and a fixed legend 70 that indicates the identity of these quantities to the user. While memory usage indicator 14d gives a user more information on the status of the pending print job than the other example memory usage indicators described above, it is not independent of the computing platform from which the print job originated. Whereas all other exemplary memory usage indicators described above display only a representation of the amount of raw data in a print job, and thus may not interpret the PDL instructions contained within the document, memory usage indicator 14d may read instructions in a variety of different versions of different PDLs. Thus, memory usage indicator 14d may be implemented by more complex software than the other memory use indicators described herein.

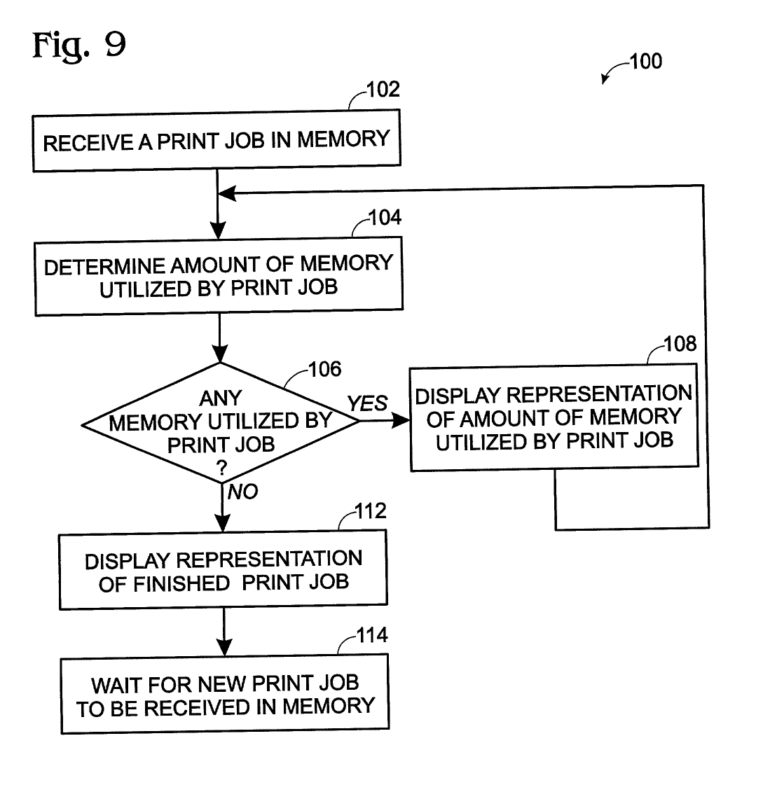

As described above, memory usage indicator 14 may be configured to show the progression of a pending print job by periodically retrieving information regarding the amount of memory occupied by a pending print job, and updating display 13 to represent the progression of the print job. Any suitable method may be used to show the representation of the print job progression. One suitable method is shown generally at 100 in FIG. 9. Method 100 includes first receiving a print job in memory at 102, and then determining an amount of memory utilized by the pending print job at 104. Determining an amount of memory utilized by the pending print job at 104 may include determining how much raw data is in the memory, or may include determining how many pages still to be printed are in the memory. The amount of memory occupied by the print job will typically be determined when the print job is received.

Once it is verified at 106 that the print job occupies at least some memory, printing commences, and memory usage indicator 14 next displays a representation of the amount of memory utilized by the pending print job at 108. After some predetermined interval of printing, the amount of memory occupied by the pending print job may again be determined at 104, and the representation of the amount of memory may again be displayed at 108, both of which may be performed while the print job is being continuously printed. Steps 104-108 are repeated until the print job has been completely printed. The amount of memory occupied by the pending print job may be determined in any suitable manner, such as the counter methods described earlier herein.

Once printing of the pending print job has been completed, it may be determined at 106 that no memory may be occupied by the pending print job. At this point, a representation of the finished print job is displayed at 112, and printing device 10 may then wait for receipt of a new print job at 114.

The disclosure set forth above encompasses multiple distinct inventions with independent utility. Although each of these inventions has been disclosed in its preferred form(s), the specific embodiments thereof as disclosed and illustrated herein are not to be considered in a limiting sense, because numerous variations are possible. The subject matter of the inventions includes all novel and nonobvious combinations and subcombinations of the various elements, features, functions, and/or properties disclosed herein. The following claims particularly point out certain combinations and subcombinations regarded as novel and nonobvious and directed to one of the inventions. These claims may refer to “an” element or “a first” element or the equivalent thereof; such claims should be understood to include incorporation of one or more such elements, neither requiring nor excluding two or more such elements. Inventions embodied in other combinations and subcombinations of features, functions, elements, and/or properties may be claimed through amendment of the present claims or through presentation of new claims in this or a related application. Such claims, whether directed to a different invention or to the same invention, and whether broader, narrower, equal, or different in scope to the original claims, also are regarded as included within the subject matter of the inventions of the present disclosure.

We claim:

1. A printing device, comprising:
memory configured to receive and store a pending print job;
a print engine configured to print the pending print job onto a medium;
a processor configured to determine an amount of memory utilized by the pending print job; and
a memory usage indicator configured to display to a user a representation of the amount of memory utilized by the pending print job.

2. The printing device of claim 1, wherein the memory usage indicator is periodically updated to indicate progress in printing.

3. The printing device of claim 1, wherein the memory usage indicator is configured to present a representation of an amount of memory that is not occupied by the pending print job.

4. The printing device of claim 1, wherein the memory usage indicator is configured to present a representation of an amount of memory that is occupied by the pending print job.

5. The printing device of claim 1, wherein the memory usage indicator is configured to present a number of pages of the pending print job remaining to be printed.

6. The printing device of claim 1, wherein the memory usage indicator includes a display configured to display a graphical representation of the amount of the memory utilized by the pending print job.

7. The printing device of claim 6, wherein the memory usage indicator includes a bar, the length of which indicates memory usage.

8. The printing device of claim 6, wherein the memory usage indicator includes a pie chart.

9. The printing device of claim 1, wherein the memory usage indicator includes an alphanumeric display.

10. A printing device configured to receive a print job and print the print job onto a medium, the printing device comprising:
memory configured to receive and store the print job;
a print engine configured to print the print job onto a medium;
a processor configured to determine an amount of memory utilized by the print job; and
a display configured to display a resource indicator that indicates the amount of the memory utilized by the print job.

11. The printing device of claim 10, wherein the resource indicator includes a graphical representation of the amount of memory utilized by the pending print job.

12. The printing device of claim 10, wherein the resource indicator includes an alphanumeric representation of the amount of memory utilized by the pending print job.

13. The printing device of claim 10, wherein the resource indicator is updated periodically to indicate progression of the pending print job.

14. The printing device of claim 10, wherein the resource indicator is configured to show an amount of memory not occupied by the pending print job.

15. The printing device of claim 10, wherein the resource indicator is configured to show an amount of memory occupied by the pending print job.

16. A printing device configured to receive a print job from an external device and print the print job onto a medium, the printing device comprising:
memory configured to store the print job while the print job is pending;
a print engine configured to print the print job onto the medium; and
progress indicator means configured to display a representation of the progression of the pending print job to a user during printing of the pending print job.

17. In a printing device having memory configured to store a pending print job, a method for indicating progression of the pending print job to a user of the printing device, the method comprising the steps of:
determining an amount of memory utilized by the pending print job; and
presenting a representation of the amount of memory utilized by the pending print job to the user.

18. The method of claim 17, wherein determining an amount of memory utilized by the pending print job in the memory includes determining an amount of data stored in the memory.

19. The method of claim 17, wherein determining an amount of memory utilized by the pending print job in the memory includes determining a number of pages to be printed.

20. The method of claim 17, further comprising periodically repeating the presenting and displaying steps during printing of the pending print job to represent changes in the amount of memory utilized by the pending print job over time.

21. The method of claim 17, wherein presenting a representation of the amount of memory utilized by the pending print job includes displaying a graphical representation of the amount of memory utilized by the pending print job.

22. The method of claim 17, wherein presenting a representation of the amount of memory utilized by the pending print job includes displaying an alphanumeric representation of the amount of memory utilized by the pending print job.

23. The method of claim 17, wherein presenting a representation of the amount of memory utilized by the pending print job includes displaying a representation of the amount of memory not occupied by the pending print job.

24. The method of claim 17, wherein presenting a representation of the amount of memory utilized by the pending print job includes displaying a representation of the amount of memory occupied by the pending print job.

25. An article including a storage medium having a plurality of machine-readable instructions stored thereon, the instructions being executable by a printing device to perform a method of indicating progression of a pending print job to a user of the printing device, the printing device having memory configured to store the pending print job, the method comprising the steps of:
determining an amount of memory utilized by the pending print job; and
presenting a representation of the amount of memory utilized by the pending print job to the user.
